(19) United States
(12) Patent Application Publication
(10) Pub. No.: US 2009/0270569 A1
(43) Pub. Date: Oct. 29, 2009

(54) ACTIVATORS FOR THE HOMO-OR CO-POLYMERISATION OF ALPHA-OLEFINS WITH HOMOGENEOUS METALLOCENE CATALYST SYSTEMS

(75) Inventors: Sergei Mikhailovich Aldoshin, Chernogolovka (RU); Natalia Mikhailovna Bravaya, Marchovelette (RU); Andrei Nikolaevich Panin, Chernogolovka (RU); Olga Mikhallovna Chukanova, Chernogolovka (RU); Abbas Razavi, Mons (BE)

Correspondence Address: FINA TECHNOLOGY INC, PO BOX 674412, HOUSTON, TX, 77267-4412, US

(73) Assignees: TOTAL PETROCHEMICALS RESEARCH FELUY, Seneffe (Feluy) (BE); INSTITUTE OF PROBLEMS OF CHEMICAL PHYSICS OF THE RUSSIAN ACABEMY OF SCIENCES, Moscow (RU)

(21) Appl. No.: 12/301,637

(22) PCT Filed: May 23, 2007
(86) PCT No.: PCT/RU07/00255

§ 371 Date: Nov. 20, 2008

(30) Foreign Application Priority Data
May 26, 2006 (RU) 2006/000273
Jul. 24, 2006 (RU) 2007/000395

(51) Int. Cl. C08F 4/52

(52) U.S. Cl. 526/127

(57) ABSTRACT

The present invention discloses a class of metallocene catalyst systems suitable for the homogeneous polymerisation of ethylene or alpha olefins that does not require the addition of aluminoxane or perfluorophenylborates as activating agent.

The present invention relates to the field activators in the homogeneous homo- and co-polymerisation of ethylene and propylene with metallocene catalyst system. These activators are very active when compared to other substituted zirconocenes but do not include aluminoxane or perfluorophenylborate.

The polymerisation of olefins in the presence of metallocene complexes has mostly been described in homogeneous catalysis. In that type of polymerisation, the catalyst, the olefin monomer and the resulting polymer are all present in the same liquid phase, typically a solvent.

Homogeneous catalyst systems are however not adapted to suspension or gas phase polymerisation. These processes nevertheless offer many advantages such as for example, the preparation of a polymer in granular form having a defined particles size distribution.

The most commonly employed activating agents in metallocene catalysis are aluminoxane and perfluorophenylborates such as for example CPh₃B(C₆F₅)₄ or Me₂NHPhB(C₆F₅)₄. These activators are costly.

Metallocene catalytic systems are “single-site” as opposed to “multi-site” heterogeneous Ziegler-Natta (ZN) catalyst systems. They produce fractionally uniform polyolefins with low polydispersity index. They also allow, contrary to Ziegler-Natta catalyst systems, the preparation of a wide range of polyolefins with properties varying from thermoplasts to elastomers. They are further characterised by very little differences in reactivity ratios of comonomers thereby allowing the possibility of varying over a wide range both the type and content of comonomer in generated copolymers. See for example J. A. Ewen, Metallocene Polymerization Catalysts: Past, Present and Future, in Metallocene Based Polyolefins, Eds. J. Scheirs and W. Kaminsky, Wiley, New-York, 1999.

In another approach, Panin et al. (In A. N. Panin, Z. M. Dzhabieva, P. M. Nedorezova, T. I. Tsvetkova, S. L. Saratovskikh, O. N. Babkina, N. M. Bravaya, in Journal of Polymer science: Part A: Polymer Chemistry, 39, 1915, 2001) have tested cheap aluminum alkyls in the activation of 2-substituted dimethylated zirconocenes. These catalyst systems were only active in homogeneous polymerisation of ethylene or propylene under very specific conditions.

Aluminum alkyls were also used for activating dimethylated bisindenylzirconocenes in copolymerization of ethylene with propylene and with hexene-1, and in copolymerization of propylene with hexene-1 as described in Russian patent application n^{o} 2250237. The activity of these homogeneous catalytic systems was however very moderate.

Zirconocenes such as rac-(2-R,4PhInd)₂ZrX₂ wherein R is Me, Et, or i-Pr and wherein X is Cl or Me or such as rac-(2-Me-Benz[e]Ind)₂ZrCl₂ are known to be highly active and stereoselective for the preparation of isotactic polypropylene. They are also very active for olefin copolymerisation. They are fully described in Resconi et al. (in L. Resconi et al., Chem. Rev., 2000, 100, 1253). These metallocene components are however activated with the usual aluminoxane or perfluorophenylborate activators and that document does not at all mention the possibility of activating them with aluminiumalkyls.

There is thus a need to develop new metallocene catalytic systems that do not require aluminoxane or perfluorophenylborates for activation, which show high activity in homogeneous homo- and co-polymerization of olefins, and which allow varying the comonomer content and distribution over a broad range.

It is an aim of the present invention to provide highly active metallocene catalyst systems that do not require aluminoxane or perfluorophenylborates in homogeneous homo- or co-polymerisation of ethylene or alpha-olefins.

It is another aim of the present invention to provide metallocene catalyst systems that are active in the homogeneous homo- or co-polymerisation of ethylene or alpha-olefins.

It is also an aim of the present invention to provide metallocene catalyst system that can produce copolymers having a broad range of comonomer content.

It is a further aim of the present invention to provide a method for activating very efficiently homogeneous metallocene catalyst components without aluminoxane or perfluorophenylborate activators for the production of homo- or co-polymers of ethylene and alpha-olefins or of propylene and ethylene or higher alpha-olefins.

Any one of those aims is fulfilled, at least partially, by the present invention.

Accordingly, the present invention provides a very active homogeneous metallocene catalyst system that is prepared without aluminoxane and perfluorophenylborate activators and is very efficient for copolymerising ethylene and alpha-olefins or propylene and ethylene or higher alpha-olefins.

The present invention provides an active homogeneous metallocene catalyst system comprising:
an activating agent of general formula

AlR″₃

wherein each R″ is the same or different and is selected from alkoxy or alkyl groups having from 1 to 12 carbon atoms;
an olefin;
and a dialkylated metallocene catalyst component of general formula I

R*ₛ(R^{a}R^{b}Ind)₂MQ₂ (I)

or of formula II

R*ₛ(R^{a}R^{b}Ind)ZR^{c}MQ₂ (II)

wherein
Ind is an indenyl or hydrogenated indenyl;
R^{a} and R^{b} are each independently selected from hydrocarbyl having from 1 to 20 carbon atoms;
R* is an optional structural bridge between the two indenyls or between an indenyl and the heteroatom, imparting stereorigidity to the complex;
s is 0 if the bridge is absent and 1 if the bridge is present
M is a metal Group 4 of the Periodic Table;
each Q is independently selected from alkyl having from 1 to 6 carbon atoms or unsubstituted or substituted with benzene;
Z is an heteroatom selected from N, O or P;
R^{c} is a bulky substituent on the heteroatom that has at least 3 carbon atoms.

Preferably, substituent R^{a} is at 2-position of indenyl ligand. Preferably substituent R^{b} is at 4-position of indenyl ligand or is substituted or unsubstituted benzene[e], conjugated with indenyl ligand at 4,5-positions. Preferably R^{a} and R^{b} are respectively at positions 2 and 4 of each indenyl group and they are alkyl having from 1 to 12 carbon atoms or aryl having from 6 to 8 carbon atoms. Among the most preferred substituents, one can cite methyl, t-butyl, unsubstituted or substituted phenyl.

The type of bridge between the ligands in the present catalyst component is not particularly limited. Typically R* comprises an alkylidene group having from 1 to 20 carbon atoms, a germanium group (e.g. a dialkyl germanium group), a silicon group (e.g. a dialkyl silicon group), a siloxane group (e.g. a dialkyl siloxane group), an alkyl phosphine group or an amine group. Preferably, the substituent on the bridge comprises a silicon atom or a hydrocarbyl radical having at least one carbon, such as a substituted or unsubstituted ethylenyl radical, for example —CH₂—CH₂— (Et). Most preferably R* is Et, Me₂Si or Ph₂C.

In a preferred embodiment according to the present invention, M is selected from zirconium, titanium or hafnium. More preferably M is zirconium.

Preferably both Q are the same, more preferably they are methyl, unsubstituted or substituted with benzene.

Preferably, Z is nitrogen.

Preferably, the activating agent is an aluminiumalkyl. Especially suitable aluminiumalkyl are trialkylaluminium, the most preferred being triisobutylaluminium (TIBAL).

Without being bound by a theory, it is speculated that both trialkylaluminium and olefin participate in the initiation process according to the following reaction scheme.

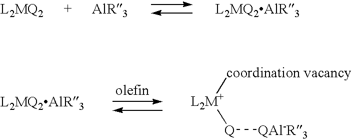

wherein L is the ligand.

As each indenyl, according to the present invention, carries two substituents, the resulting metallocene complex activated with trialkylaluminum is not a very tight complex and the olefin further helps dissociate the complex with the formation of cationic active species.

The dialkylation of the metallocene was carried out using a conventional method such as described for example by Girardello et al. (M. A. Girardello, M. S. Eisen, C. L. Stren in J. Am. Chem. Soc. 117, 12114, 1995.) Alkyllithium was added dropwise at a temperature of about −80° C. to dichlorinated metallocene and the system was heated slowly to a temperature of at least 20° C. Dialkylated metallocene was then separated out.

The metallocene catalyst system of the present invention is very active in homogeneous homo- or co-polymerisation of ethylene with alpha-olefins or of propylene with ethylene or higher alpha-olefins.

The present invention also provides a method for homogeneous homo- or co-polymerisation of ethylene or alpha-olefins that comprises the steps of:
a) adding aluminium alkyl to a solvent in an amount to reach concentration of at least 1.10⁻² mol/L;
b) adding the monomer into the solution of step a) until a constant concentration is obtained;
c) adding the optional comonomer;
d) adding the catalyst component of the present invention;
e) maintaining under polymerising conditions;
f) retrieving a homo- or co-polymer.

The amount of activating agent in the catalyst system is selected to give Al/M ratio of from 10 to 10000, preferably from 50 to 500 and more preferably of about 80 to 300.

The polymerisation temperature can range from −100 up to 200° C. Preferably it is of from 20 to 80° C. and the polymerisation time varies between a few minutes and several hours, preferably from 3 minutes to 2 hours.

The preferred monomers are ethylene and propylene. The comonomers for ethylene are preferably propylene and hexene-1. The comonomers for propylene are preferably ethylene and hexene-1.

The following examples are intended to illustrate the invention but the invention is not restricted to those examples.

### EXAMPLES 1 TO 3

Several polymerisations were carried out with the catalyst systems according to the present invention.

The catalyst component was

rac-Me₂Si(2-Me,4-Ph-Ind)₂ZrMe₂
wherein Ind is indenyl, Me is methyl and Ph is phenyl.

Homogeneous homopolymerisation of ethylene and of propylene as well as copolymerisation of ethylene and propylene were carried out using triisobutylaluminium (TIBAL) as activating agent. All homo- and copolymerisation were carried out in a 200 ml stainless steel reactor. The reactor was pumped at 90° C. for one hour. 60 ml of toluene, the desirable amount of TIBAL, and monomer(s) were introduced into the reactor in series. After equilibrium was reached, the vial containing the catalyst component was broken to start the polymerisation. At the end of the polymerisation process the monomer injection was interrupted and the polymer was collected. The polymer was then washed with ethanol containing 10 wt % of HCl, and afterwards, it was washed three times with a water/ethanol mixture, and dried under vacuum at a temperature of 60° C. until constant weight was reached. The polymerisation conditions and results are summarised in Table 1.

TABLE I

| | | Zr · 10⁶ | [Zr] · 10⁵ | Al/Zr | T | P | T | Yield | A* |
|---|---|---|---|---|---|---|---|---|---|
| Run | M_{M}/M_{C} ^{(a)} | mol | mol/L | mol/mol | ° C. | bar | min | g | g/g/h |
| 1 | homo-C2 | 1.56 | 2.6 | 380 | 50 | 11 | 1.9 | 9.7 | 176.3 |
| 2 | homo-C3 | 1.73 | 2.9 | 380 | 50 | 2 | 20 | traces | — |
| 3 | homo-C3 | 0.95 | 1.6 | 630 | 50 | 2 | 21 | 2.3 | 9.1 |
| 4 | homo-C3 | 0.61 | 1.0 | 980 | 50 | 4 | 3.7 | 4.0 | 66.5 |
| 5 | homo-C3 | 0.70 | 1.2 | 850 | 50 | 4 | 6.7 | 8.2 | 65.6 |
| 6 | homo-C3 | 0.42 | 0.7 | 1430 | 50 | 4 | 3.7 | 5.2 | 125.5 |
| 7 | homo-C3 | 1.56 | 2.6 | 380 | 50 | 6 | 2.2 | 10.0 | 72.8 |
| 8 | homo-C3 | 0.70 | 1.2 | 850 | 50 | 6 | 2.3 | 9.0 | 139.8 |
| 9 | C2/C3 = 0.7/1 | 1.56 | 2.6 | 380 | 50 | 11 | 1.5 | 11.6 | 151.0 |
| 10 | C3/C2 = 1/0.05 | 0.57 | 1.0 | 1050 | 30 | 4 | 5.8 | 4.7 | 41.2 |
| 11 | C3/C2 = 1/0.05 | 0.42 | 0.7 | 1430 | 50 | 4 | 3.5 | 3.2 | 93.1 |
| 12 | C3/C2 = 1/0.05 | 0.45 | 0.8 | 1330 | 70 | 4 | 2.6 | 4.4 | 217.0 |
| 13 | C3/H-1 = 1/0.03 | 0.62 | 1.0 | 970 | 50 | 4 | 6.5 | 4.5 | 40.9 |
| 14 | C3/H-1 = 1/0.05 | 0.47 | 0.8 | 1280 | 50 | 4 | 25 | 1.53 | 4.7 |

*The activity A of the catalyst system is expressed in kg of polymer per mol of Zr per hour per monomer(s) concentration in mol/l.
^{(a)} The ratio M_{M}/M_{C} represents the ration of monomer and comonomer in the feed. For example in run 9, the monomer is ethylene and the comonomer is propylene.
The activity of catalyst system in homopolymerisation is much higher for ethylene than for propylene as observed by comparing run 1 for ethylene with runs 2 to 8 for propylene.

There is a non-linear increase of catalyst activity, related to monomer concentration, with increasing monomer pressure as can be seen by comparing run 3 (propylene pressure=2), run 6 (propylene pressure=4), and run 8 (propylene pressure=6).

Increase of TIBAL concentration leads to increase of activity (compare entries 2,3 and 5,6).

The catalyst system of the present invention is also very active in the preparation of ethylene/propylene copolymers as can be seen in runs 9 to 12. The effective value of activation energy is of about 8.6±0.1 kcal/mol within the range of temperature of from 30 to 70° C. used in the examples.

The catalyst system is also active in the preparation of propylene/hexene-1 copolymers as seen in runs 13 and 14. It is however less active than in the copolymerisation of ethylene with propylene.

### COMPARATIVE EXAMPLES 1 TO 4

For comparison mono-2-substituted bisindenyl zirconocenes were used in the homogeneous homopolymerisation of ethylene and in the homogeneous copolymerisation of ethylene and propylene. The polymerisation conditions and results are displayed in Table II. The metallocene catalyst component used for comparison were rac-Et(2-MeInd)₂ZrMe₂ (C1), rac-Me₂Si(2-MeInd)₂ZrMe₂ (C2) and (2-PhInd)₂ZrMe₂ (C3).

TABLE II

| | | Zr · 10⁶ | [Zr] · 10⁵ | Al/Zr | T | P | T | Yield | A* |
|---|---|---|---|---|---|---|---|---|---|
| Cata. | M_{M}/M_{C} | mol | mol/L | mol/mol | ° C. | bar | min | g | g/g/h |
| C1 | homo-C2 | 5.90 | 8.5 | 300 | 30 | 11 | 18 | 3.4 | 1.28 |
| C1 | C2/C3 = 0.7/1 | 4.80 | 8.0 | 90 | 30 | 11 | 2.4 | 13.7 | 26.04 |
| C2 | homo-C2 | 4.80 | 8.0 | 300 | 30 | 11 | 4.1 | 8.1 | 16.51 |
| C2 | homo-C3 | 3.90 | 5.6 | 300 | 30 | 0.6 | 20 | 0.22 | 0.47 |
| C2 | C2/C3 = 0.7/1 | 3.10 | 5.0 | 120 | 30 | 11 | 2.9 | 11.0 | 26.80 |
| C3 | homo-C2 | 4.80 | 8.0 | 300 | 30 | 11 | 60 | 3.7 | 0.51 |
| C3 | homo-C3 | 3.5 | 5.4 | 300 | 30 | 6 | 60 | 5.9 | 0.47 |

It can be concluded from these experiments that the catalyst systems based on di-substituted indenyl ligands according to the present invention, activated with TIBAL had a much higher activity in homogeneous homo and co-polymerisation of ethylene and propylene than those based on mono-2-substituted indenyl ligands.

1. An active homogeneous catalyst system comprising:
a) an activating agent of general formula
AlR″₃
wherein each R″ is the same or different and is selected from alkoxy or alkyl groups having from 1 to 12 carbon atoms;
b) an olefin;
c) a dialkylated metallocene catalyst component of general formula I
R*ₛ(R^{a}R^{b}Ind)₂MQ₂ (I)
or of formula II
R*ₛ(R^{a}R^{b}Ind)ZR^{c}MQ₂ (II)
wherein
Ind is an indenyl or hydrogenated indenyl;
R^{a} and R^{b} are each independently selected hydrocarbyl having from 1 to 20 carbon atoms;
R* is an optional structural bridge between the two indenyls or between one indenyl and heteroatom Z, imparting stereorigidity to the complex;
s is 0 if the bridge is absent and 1 if the bridge is present
M is a metal Group 4 of the Periodic Table;
each Q is independently selected from alkyl having from 1 to 6 carbon atoms unsubstituted or substituted with benzene;
Z is an heteroatom selected from N, O or P;
R^{c} is a bulky substituent on the heteroatom that has at least 3 carbon atoms.

2. The active homogeneous catalyst system of claim 1 wherein substituents R^{a} and R^{b} on the indenyl groups are in positions 2 and 4 and are each independently selected from alkyl groups or aryl groups having at most 12 carbon atoms.

3. The active homogeneous catalyst system of claim 1 wherein substituent R^{a} is at 2-position on each indenyl group and is selected from alkyl group or aryl grous having at most 12 carbon atoms, and substituent R^{b} is a substituted or unsubstituted benzene[e] conjugated at 4,5-positions with each indenyl group.

4. The active homogeneous catalyst system of claim 1 wherein bridge R* is present.

5. The active homogeneous catalyst system of claim 4 wherein the bridge is Et, Me₂Si or Ph₂C.

6. The active homogeneous catalyst system of claim 1 wherein the Q's are the same and are methyl groups.

7. The active homogeneous catalyst system of claim 1 wherein M is zirconium.

8. The active homogeneous catalyst system of claim 1 wherein Z is N.

9. The active homogeneous catalyst system of claim 1 wherein the activating agent is an aluminium alkyl.

10. The active homogeneous catalyst system of claim 9 wherein aluminium alkyl is TIBAL.

11. A method for preparing an active homogeneous catalyst components that comprises the steps of:
a) providing the dimethylated catalyst component of claim 1, wherein Q is methyl;
b) adding aluminium alkyl;
c) in the presence of one or more olefin(s).

12. A method for the homogeneous homo- or co-polymerisation of ethylene or alpha-olefins that comprises the steps of:
a) adding aluminium alkyl to a solvent in an amount to reach concentration of at least 1.10⁻² mol/L;
b) adding the monomer into the solution of step a) until a constant concentration is obtained;
c) adding the optional comonomer;
d) adding the active homogeneous catalyst component of claim 1;
e) maintaining under polymerising conditions;
f) retrieving a homo- or co-polymer.

13. The method of claim 12 wherein the monomer and/or comonomer is selected from ethylene, propylene or hexene-1.
